(19) United States
(12) Patent Application Publication
(10) Pub. No.: US 2004/0220845 A1
(43) Pub. Date: Nov. 4, 2004

(54) System and method of automated package tracking

(76) Inventor: Cynthia Malapitan, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/427,503

(22) Filed: Apr. 30, 2003

(51) Int. Cl. G06F 17/60

(52) U.S. Cl. 705/8

(57) ABSTRACT

A computerized system for managing and tracking automated package delivery. Upon ordering of a product from a vendor on-line, transaction-related information is placed on the customer's computer by the vendor's computer. Transaction-related information is also placed on the customer's computer by the shipper responsible for transporting the product from the vendor's location to the customer's location. A tracking module on the customer's computer reads the information left on the customer's computer by the vendor and shipper and generates and displays a customer-interface form listing relevant shipping information for the customer to view and make changes on. Customer changes to the shipping information are sent back to the vendor's computer and shipper's computer by the customer's tracking system. If the shipping changes are made by the vendor and/or shipper, the information is sent back to the customer's computer, for processing by the tracking module, and displayed on the updated customer-interface form.

### TECHNICAL FIELD

The present invention relates to computerized information tracking systems and methods and, more particularly, to computerized systems for tracking and controlling packages shipped from a shipper location to a customer location.

### BACKGROUND OF THE INVENTION

The rapid growth of the World Wide Web (“Web”) has facilitated the development of a new sector of the economy generally known as “e-commerce.” The Web can provide vast amounts of information to requested parties. In addition, Web users are able to seek out and purchase a large variety of products and services through the convenience of web-enabled communication devices. Web-enabled communication devices include personal computers, personal digital assistants, wireless devices such as cellular telephones, satellite telephones, WI-FL- and Blue-Tooth-enabled personal computers and proprietary electronic devices or any other electronic device intended for the communication of information. For clarity in the following discussion, any of the above-described web-enabled communication devices is generally referred to as a “customer computer.”

E-commerce broadly comprehends the process of a customer either seeking out, or being advised of, product and service information available for purchase from a vendor. Customers include individual consumers, small businesses, and large corporations. Similarly, vendors include individuals offering a one-time, casual sale, small business venders, and large corporations offering comprehensive packages of goods and services designed to meet the complex needs of the customer. For purposes of this discussion, a sale is comprised of a transaction and a delivery. The transaction generally occurs over a communications network, such as the Internet, but may equally occur over another communications network, such a public switch telephone network (“PSTN”), or a private network such as an order-fulfillment system administered on an intra-company local area network.

Generally, the transaction comprises a customer researching the product, specifying delivery information for the product, and purchasing the product from the vendor. Once the transaction is complete, the vendor furnishes the product to a shipper for delivery of the product to the customer. There are many independent shipping companies available to vendors, including United Parcel Service, Federal Express, and the United States Postal Service. In addition, the vendor may utilize the vendor's own shipping division, such as a delivery service of a department store that delivers furniture, appliances, or other items to customers.

A conventional e-commerce transaction begins with a customer researching and buying a product through a vendor's web page. As part of the purchase, the customer enters delivery information for the product. The vendor processes the transaction and furnishes the product to a shipper for delivery to the customer. The shipper provides a tracking number to identify the product shipment. Often, the vendor advises the customer of the shipment of the product and makes the tracking number available to the customer for use by the customer, should the customer wish to track the shipping progress of the order. To discover this tracking number, the customer makes a return visit to the vendor's web site, logs in to the customer's account, and retrieves a copy of the customer's order. The displayed order summary generally includes the date of shipment, the name of the shipper, and a tracking number. For example, certain parcel delivery services currently use an 18-digit tracking number to identify a shipment. Some vendors display this tracking number as a hyperlink that, when activated, displays tracking information for that particular order. Additionally, some shippers provide web sites where a customer can input known tracking numbers to discover tracking information about the product shipment. However, obtaining any shipping information is predicated upon first obtaining a tracking number for a particular shipment and then inputting that tracking number into the shipper web site, generally either directly or through a hyperlink from the vendor's web site.

An active e-commerce customer, however, may be concurrently awaiting several different orders at any given time. Moreover, these orders may be shipped using a variety of shippers from a variety of vendors. Currently, if the customer wishes to track each of these individual shipments, the customer needs to visit each vendor site, log in to the customer's accounts, and individually access each order to obtain the name of the shipper and the tracking number. The customer needs to then log into each shipper site to view the shipping information for each shipment, using each different tracking number.

Accordingly, customers, vendors, and shippers have recognized a need for a system that permits a customer to retrieve tracking information from one or more shippers, resulting from purchases from one or more vendors, in one easy-to-use system that automatically retrieves and aggregates tracking information for that customer. Moreover, it would also be desirable to allow the customer to administer and control shipping-related activities for the various shipping events retrieved by the tracking system.

### SUMMARY OF THE INVENTION

One embodiment of the present invention is a computerized system for tracking and controlling automated package delivery. All in-bound deliveries containing a tracking number provided by a shipper are aggregated onto a customer-interface form accessible to a customer expecting a delivery. The customer-interface form allows the customer to see a listing for each delivery. Each listing contains relevant shipping information, such as the name of the shipper, the tracking number, the shipping date, the expected delivery date, and the shipping destination. The customer may then make changes to the shipping information, for example, the customer may change the shipping destination or delay the estimated delivery date.

The information contained on the customer-interface form is generated by a customer-tracking module in communication with the customer's computer. When the customer orders a package from a vendor on-line, the vendor's computer leaves transaction-related information behind on the customer's computer. Likewise, the shipper that transports the package from the vendor's location to the customer's location also leaves transaction-related information behind on the customer's computer. The customer-tracking module reads the information left behind on the customer's computer by the vendor and the shipper and displays the information for the customer in the customer-interface form. If the customer changes any of the displayed shipping information on the customer-interface form, the customer-tracking module sends this request for changes back to the vendor computer and/or the shipper computer. The vendor computer and/or the shipper computer then sends back a response to the customer's computer as to whether or not the request has been accepted. The tracking system processes the responses and updates the customer-interface form accordingly.

### BRIEF DESCRIPTION OF THE DRAWINGS

FIG. 1 is a block diagram of an exemplary environment suitable for practicing one embodiment of the present invention.

FIG. 2 is a block diagram of a customer computer, in accordance with one embodiment of present invention.

FIG. 3 is a block diagram of a vendor computer, in accordance with one embodiment of the present invention.

FIG. 4 is a block diagram of a shipper computer, in accordance with one embodiment of the present invention.

FIG. 5 is a flow chart that illustrates a customer-tracking module, in accordance with one embodiment of the present invention.

FIGS. 6A-B are a flow chart that illustrates generating a query list, in accordance with one embodiment of the present invention.

FIG. 7 is a flow chart that illustrates a vendor-tracking server module, in accordance with one embodiment of the present invention.

FIG. 8 is a flow chart that illustrates a shipper-tracking server module, in accordance with one embodiment of the present invention.

FIG. 9 is a block diagram of a query list, in accordance with one embodiment of the present invention.

FIG. 10A is a block diagram of a vendor cookie, in accordance with one embodiment of the present invention.

FIG. 10B is a block diagram of a shipper cookie, in accordance with one embodiment of the present invention.

FIG. 11 is a block diagram of a query list, in accordance with one embodiment of the present invention.

FIG. 12 is a listing of an XML schema, in accordance with one embodiment of the present invention.

FIG. 13 is a listing of an exemplary XML query/query response, in accordance with one embodiment of the present invention.

FIG. 14 is a pictorial representation of a customer-interface form, in accordance with one embodiment of the present invention.

FIG. 15 is a pictorial representation of an action-request interface, in accordance with one embodiment of the present invention.

FIG. 16 is a pictorial representation of an updated customer-interface form, in accordance with one embodiment of the present invention.

### DETAILED DESCRIPTION OF THE INVENTION

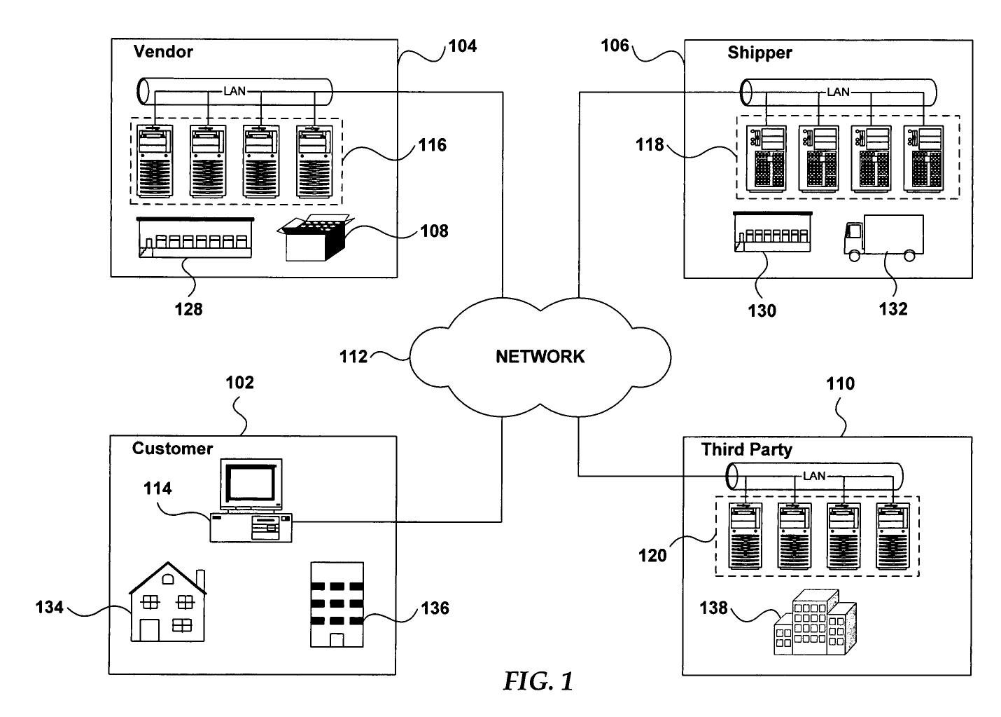

The present invention provides an automated system for the tracking and manipulation of deliveries. FIG. 1 provides an example of an environment in which the present invention operates. In the example illustrated in FIG. 1, there are three separate entities that participate in each transaction: a customer 102 who purchases a product or service 108; a vendor 104 from where the product is purchased; and a shipper 106 who transports the product or service, generally as a package 108 from the shipper's location 130 to the customer 102. In addition, the shipper 106 may also transport the product or service 108 (collectively referred to as a “product”) from the vendor 104 to the shipper's location 130. The present invention anticipates that there will often be a plurality of customers 102, vendors 104, and shippers 106, which may interact in any permutation. For example, a customer 102 may order one or more products 108 from a plurality of vendors 104, which are then shipped to the customer 102 using one or more shippers 106. While customers 102, vendors 104, and shippers 106 are described as independent entities in the discussion that follows, these entities may be part of the same organization in any combination. For example, the customer 102, vendor 104, and shipper 106 may be different departments within a single organization having an internal order fulfillment system, or the customer 102 may have a product 108 shipped by a vendor 104 using the vendor's own shipping department, or the customer 102 and vendor 104 may be part of a single organization that uses a separate shipper 106 to deliver the product 108 from a distant vendor location 128 to the customer 102. In addition, any of the customers 102, vendors 104, or shippers 106 may employ one or more third-party contractors 110 to assist in, or provide any of, the functions described below that are provided by that entity.

Each entity 102, 104, and 106 may employ a plurality of locations. The customer 102 may have one or more associated delivery addresses to which the customer 102 may request delivery of the products 108. For instance, the customer 102 may have a home address 134 and an office address 136. Furthermore, the customer 102 may wish to have additional addresses 138 listed in addition to the two above stated customer delivery locations 134 and 136. Third parties 110 may be employed by the customer 102 to accept delivery and temporarily retain possession of the product 108. For instance, customer 102 may be out of town on the expected delivery date of the product 108 and desire an agent, neighbor or relative to receive delivery of the product 108. Additionally, the vendor 104 may have one or more warehouses 128 or may subcontract the services of other locations 138 from third parties 110. For instance, in a “drop-shipping” arrangement, the vendor 104 may contract with a third party 110 to supply products 108 directly to the customer 102 based upon an order taken by the vendor 104 from the customer 102. Further, the shipper 108 may have a plurality of intermediate storage locations 130 for housing the product 108 during the various stages of shipment, as well as a plurality of transportation vehicles 132, such as cars, trucks, ships, and airplanes for moving the product 108 during the process of shipment.

The various entities 102, 104, 106, and 110 utilize a communication network 112 to complete each purchase transaction. In the preferred embodiment of the present invention, the communication network 112 is the World Wide Web (“Web”). The Web comprises a plurality of communication protocols for transmitting and receiving electronic information in information units commonly referred to as documents or “web pages.” A web page comprises data and meta-data. Data generally comprises information that will be used by a customer program (described below) operating on a customer computer 114. The meta-data comprises information about data that may be used by the customer application to describe the data. In the context of web pages, meta-data elements are often referred to as “tags” which conform to a markup language such as HTML, SGML, or XML. In general, HTML tags define formatting information for the accompanying data which is used by a web browser to render a web page for presentation to the customer 102 on the customer computer 114.

Web pages are either stored or dynamically generated on server computers 116, 118, and/or 120. As will become apparent below, the preferred embodiment of the present invention is intended as a distributed system with vendor web pages and shipper web pages being requested and served by one or more of the servers 116, 118, or 120 in accordance with the methods of one embodiment of the present invention.

By way of overview, an exemplary purchase transaction for demonstrating and describing the present invention comprises a customer using a web browser application on the customer computer to access one or more web pages on a vendor's web servers. Vendor's web servers 116 serve, or return, a web page in accordance with criteria specified by the customer's 102 web browser on the customer's computer 114. Often this interaction between the customer's web browser and the vendor's web server 116 is iterative, as the customer 102 instructs the web browser to navigate various web pages that comprise the vendor's web site. Part of this iterative browsing of vendor's web pages may include the transmission of search criteria to the vendor's web servers 116, which the vendor's web servers 116 use to dynamically generate vendor's web pages according to the search criteria. For example, the customer 102 may visit the vendor's web site searching for a particular product 108 by first retrieving a search page from the vendor's web servers 116, entering and returning search criteria describing the product 108 to the vendor's web servers 116, which then either return a pre-prepared web document pertaining to the product 108, or dynamically generate a web page including information responsive to the search request. Once the product 108 has been identified, the customer 102 may order the product 108 utilizing the web page provided by the vendor 104. As part of a settlement process, the customer 102 provides financial information used to complete the purchase, and shipping information specifying certain shipping details used to deliver the product 108 to the customer 102.

The vendor 104 uses the shipping details to facilitate a shipment of the product 108 to the customer 102 via the shipper 106. The vendor 104 then transfers the possession of product 108 to the shipper 106 at either the vendor location 128 or the shipper location 130. Once the shipper 106 obtains possession, the shipper 106 assigns the product 108 a tracking number. The shipper 106 then transports the product 108, via delivery vehicles 132, to a delivery location specified by the customer 102 in the delivery information provided to the vendor 104. FIG. 1 shows the customer 102 having two specified delivery locations, a residence 134 and a business 136. In the process of delivering the product 108 from the vendor's location 128 to the customer's delivery location 134 or 136, the shipper 106 may utilize a plurality of shipping locations 130 and delivery vehicles 132. Generally, once the shipper 106 assigns a tracking number to the product 108, the shipper 106 is able to monitor all subsequent movement of the product 108 using a tracking application running on the shipper's servers 118, or a third party's servers 120. Each change in location of the product 108, for example from the vendor's location 128, through the plurality of shipper locations 130 and delivery vehicles 132, to the customer delivery location 134 or 136, results in a tracking event maintained by the tracking application.

Conventional tracking applications allow the vendor 104 and customer 102 to access the tracking events for a particular product 108 using the tracking number provided by the shipper 106 to the vendor 104. The vendor 104 may transmit the tracking number to the customer 102 via an email confirmation of the product order, or the customer 102 may inquire about the order via the vendor's 104 web site, and retrieve the tracking number from the vendor's web page. Alternately, the vendor 104 may provide a hyperlink available to the customer 102 that, when activated, retrieves and displays the tracking events for the shipment associated with the tracking number. Often, the customer 102 must access one or more of the shipper's web pages and manually input the tracking number associated with each delivery to obtain a separate listing of each delivery's tracking events.

One embodiment of the present invention greatly expands the functionality of tracking information available to, and controllable by, customers 102 using the functionality of conventional systems. As will be described in detail below, one described embodiment of the present invention retrieves, displays, and enables concurrent control of multiple shipping transactions through a common interface.

FIG. 1 includes a third party contractor 110 to illustrate that the various electronic systems, e.g., 116 and 118, may be performed by another entity 110 that provides a subcontracted electronic system 120. As discussed above, this third party contractor 110 can also perform other functions as well, such as storing the product 108 for the vendor 104 and/or the shipper 106, as well as receiving delivery of the product 108 for the customer 102.

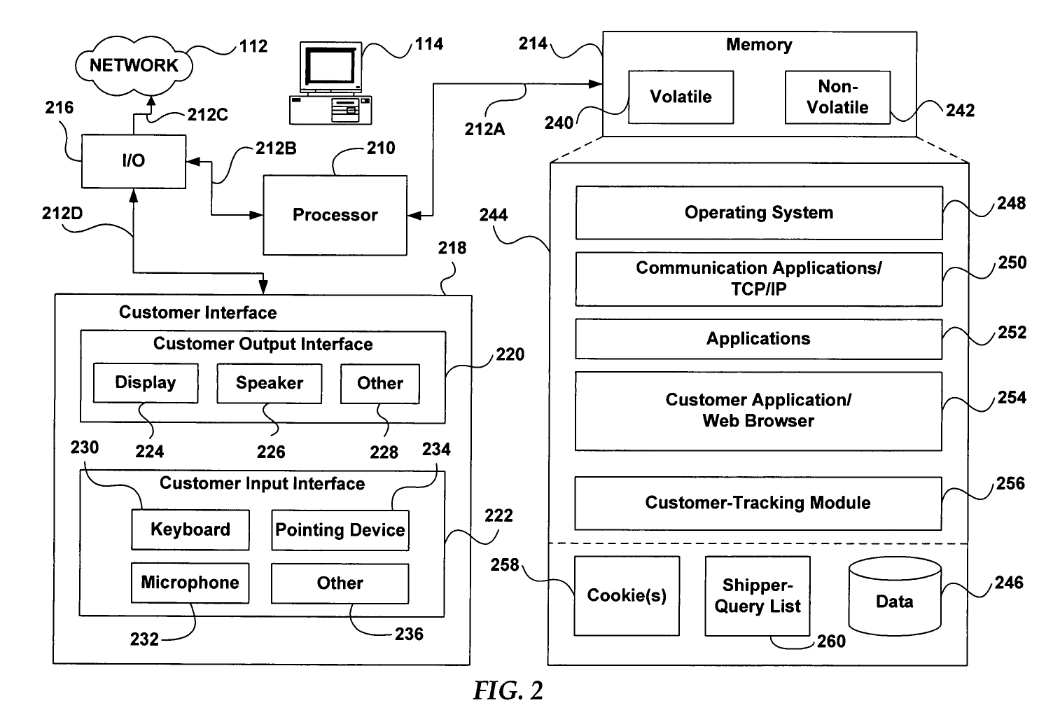

FIG. 2 shows an exemplary customer computer 114 suitable for practicing the present invention. Many devices may serve as the customer computer 114, for instance, a personal computer, cellular telephone, or personal digital assistant. The composition and assembly of computer devices is well understood in the art and will not be discussed in detail for the sake of brevity and clarity. The basic components of the customer's computer 114 is shown in FIG. 2 in block form and comprises a processor 210 that is coupled via bus 212A to electronic memory 214. The processor is also coupled via bus 212B to input/output (“I/O”) circuitry 216 that provides electronic communication to and from the electronic communication network 112 via a connection 212C and to a customer interface 218 via bus 212D. The connections provided by busses 212A-D may be the same bus individual connections or intermediate devices such as modems, wireless circuitry, or Ethernet connections.

The customer interface 218 comprises customer-output interface elements 220 and customer-input interface elements 222. Customer-output interface elements 220 are intended to communicate information to the customer from the customer computer 114. A display 224 visually conveys information, a speaker 226 aurally conveys information, and other output devices 228 may be in combination with these or include other interface means. The customer-input interface elements 222 receive input from the customer 102 to the customer computer 114. Examples of these customer-input interface elements 222 are a keyboard 230 for inputting textural information, a microphone 232 for inputting audio information, an input device 234 for indicating and selecting information via the display 224, and other devices 236, such as a touch screen display that incorporates aspects of the pointing device 234 and the display 224.

The memory 214 is conventionally segregated into volatile memory 240 and non-volatile memory 242. Volatile memory 240 (often referred to as RAM) retains its state information while powered, while non-volatile memory 242 does not require power to maintain its state over extended periods of time. Non-volatile memory 242 includes read-only memory “ROM”) and mass storage devices such as magnetic and optical disk drives and writeable electronic devices such as flash memory.

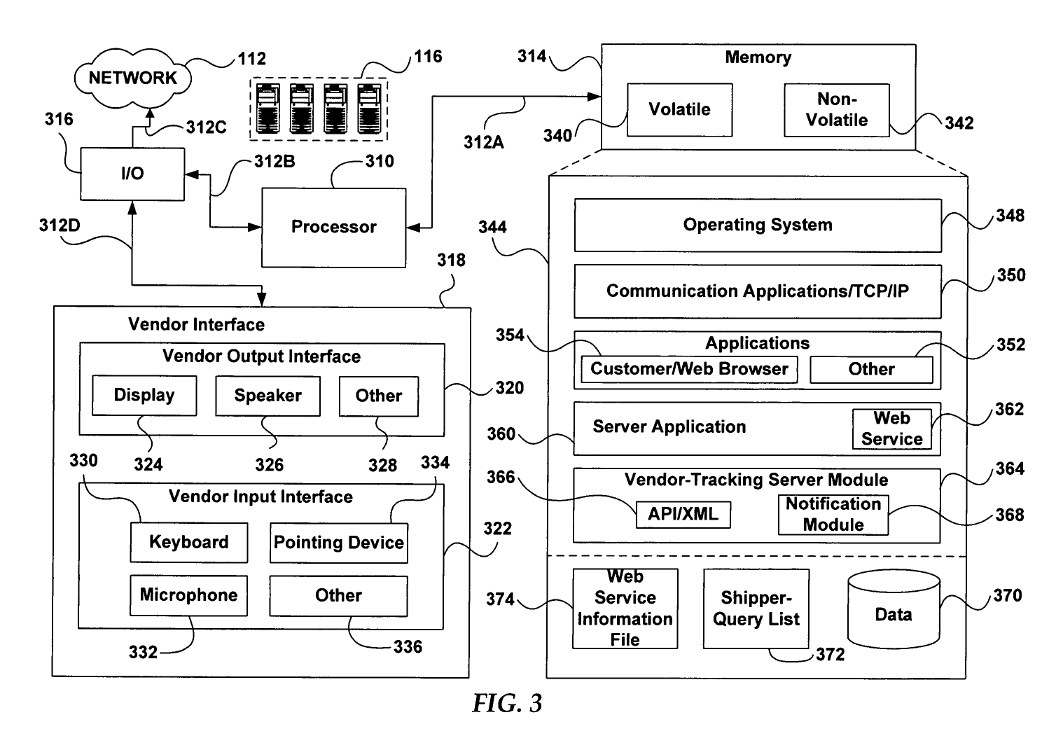

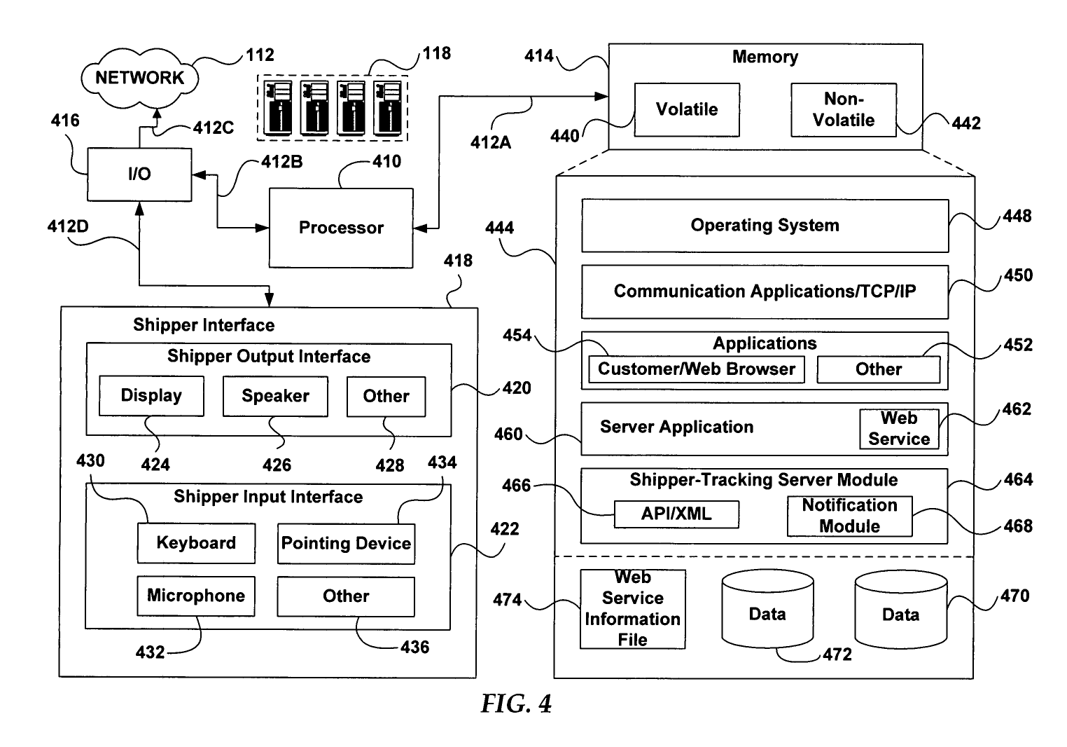

The memory 214 contains electronically encoded program instructions 244 that instruct the processor 210 in the operation of the customer computer 114 and electronic information, or data 246, on which the program instructions 244 operate. The program instructions 244 include conventional elements, such as an operating system 248, which controls the basic functionality of the customer computer 114, such as instructing the processor 210 to receive data via the customer interface 218, and displaying responsive data via the display 224. Conventional systems also include communication applications 250 that instruct the processor 210 to control the I/O elements 216 for communication of information between the customer computer 114 and the network 112. In one embodiment of the invention, communications applications 250 operate under a series of protocols that define the Internet. Application programs 252 include program instructions that employ the operating system 248 and communications application 250 to operate the customer computer 114 in a desired fashion. Customer applications 254 are a type of application 252 that generally operates in tandem with a server application (see FIGS. 3-4). In the preferred embodiment of the invention, the client application 254 comprises a web browser. The web browser 254 operates in conjunction with a web server, described below, in accordance with the methods and systems of one embodiment of the present invention. Alternatively, a specialized client application 254 may be used to implement the present invention.

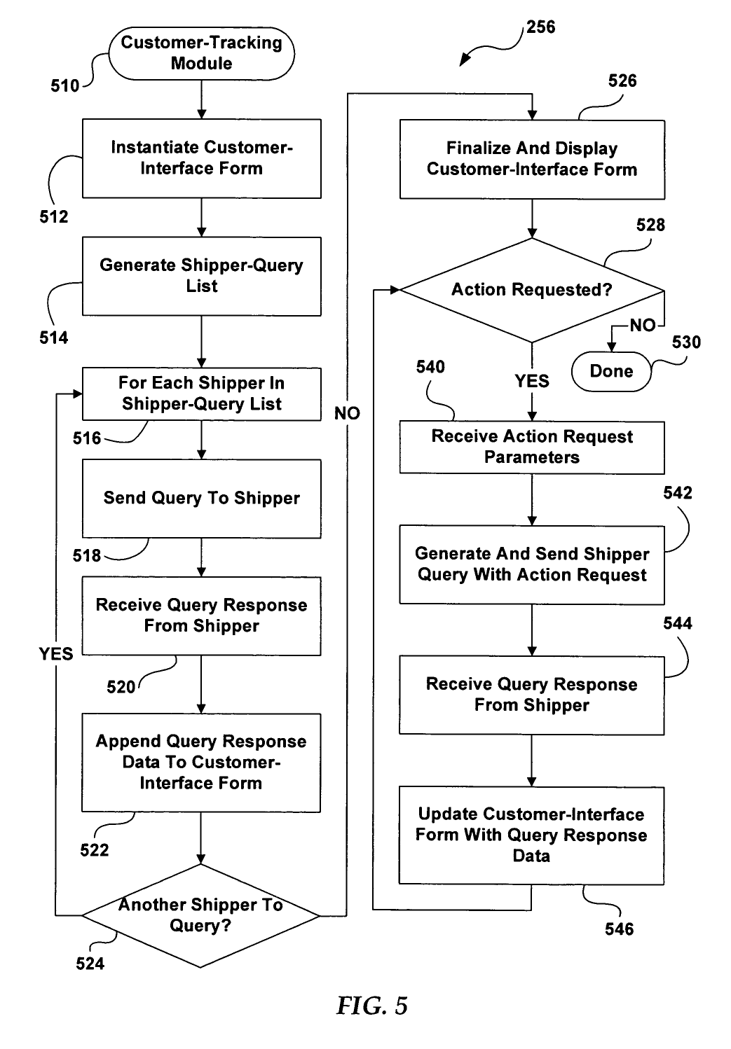

Some of the methods performed in accordance with one embodiment of the present invention are grouped for discussion in a customer-tracking module 256, which will be discussed below with reference to FIG. 5. In some instances, the customer-tracking module 256 may operate on some information stored locally in the memory 214 of customer computer 114 in one or more data files, such as a cookie 258 or a shipper list 260. A cookie file is conventionally understood as a data file left behind on a customer computer 114 that contains information that may be read from and written to, by a remote server at a web site. The customer-tracking module 256 may be implemented as an add-on to the web browser 254 or as a native program running on the customer computer 114. The customer-tracking module 256 may also read from and write to a shipper list 260 which is not limited in functionality as a cookie 258 may be. Exemplary uses for the cookies 258 and shipper list 260 are described below with reference to FIG. 5.

FIG. 3 illustrates an exemplary vendor server suitable for practicing the present invention. The vendor server, or vendor computer 116, is similar in structure and basic functionality to the customer computer (114 in FIG. 1) but generally possesses greater processing power. Server computers 116 may be grouped together in server farms connected by local area networks, combining their processing power into what appears to be a single web site available to the customer (102 in FIG. 1) by means of the customer computer (114 in FIG. 1). In general, the portions of the vendor computer 310-350 are similar in functionality to corresponding elements (210-250 in FIG. 2) of the customer computer (114 in FIG. 1).

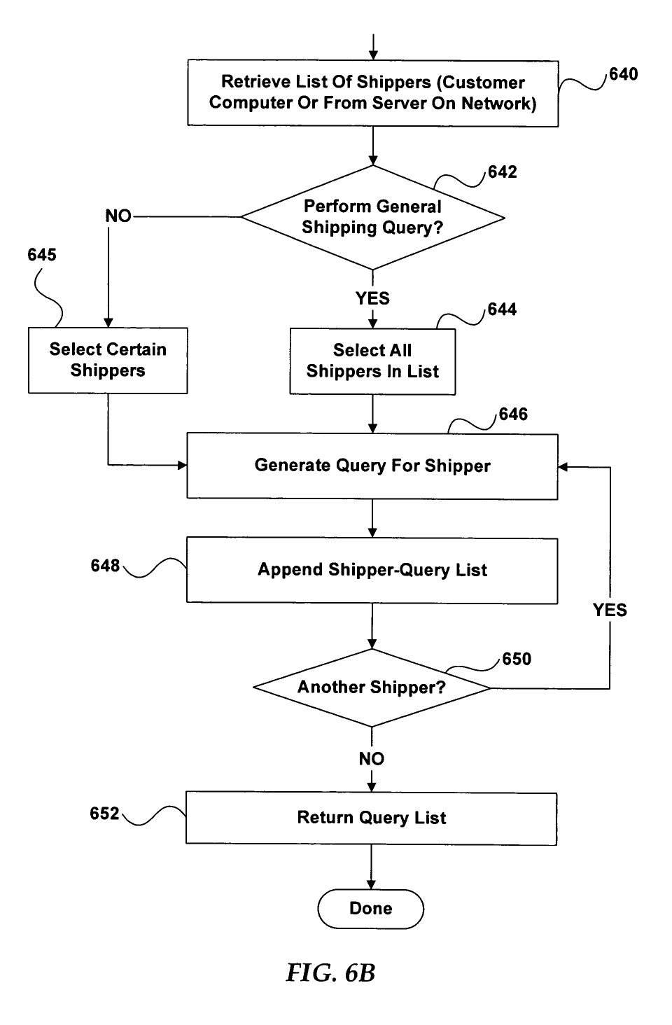

The server application 360 includes the ability to process information requests forwarded by the customer application (254 in FIG. 2), such as database queries. Generally, this is done through scripting applications that execute database queries via the parsing of HTTP requests or SQL statements. In addition to the functionality provided by the scripting applications, web services 362 provide more direct access to database information. A customer application (254 in FIG. 2) may directly access a web service 362. Some of the methods of an embodiment of the present invention implemented by the server application 360 or web service 362 are described below with reference to the vendor-tracking server module 364 shown in FIG. 7. In addition to the scripting access described above, the vendor-tracking server module 364 may provide access by the customer application 254 to various information via an application programming interface (“API”) 366 or via a markup language, such as XML. In one embodiment of the present invention, the vendor-tracking server module 364 includes a notification module 368.

The memory 314 of the vendor computer 116 may include local information files that supply data as required by the program instructions 344. This data may be stored in any conventional file format, including flat files, relational databases, and object-oriented databases. These data files may also include specialized files for the use of the vendor-tracking server module 364, such as a shipper list 372 or web service information file 374. A web service information file 374 includes information in a standardized format that defines how a customer application 254 can utilize the web service 362 to obtain data 370.

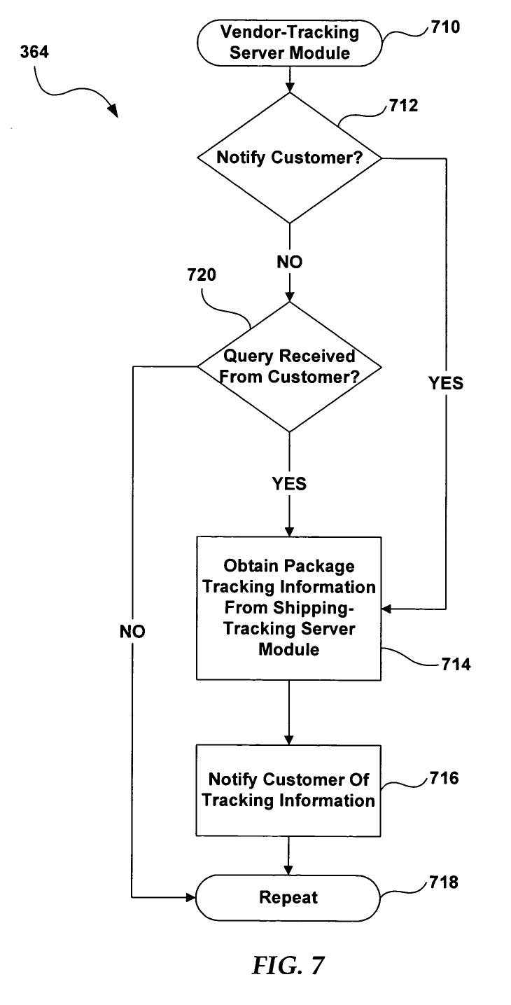

FIG. 4 illustrates an exemplary shipper server. The shipper server, or shipper computer 118, is similar in structure and basic functionality to the customer computer (114 in FIG. 1), but generally possesses greater processing power. Shipper computers 118 may be grouped together in server farms connected by local area networks, combining their processing power into what appears to be a single web site available to the customer (102 in FIG. 1) by means of the customer computer (114 in FIG. 1). In general, the portions of the shipper computer 410-450 are similar in functionality to corresponding elements (310-368 in FIG. 3) of the vendor computer (116 in FIG. 3). The shipper-tracking server module will be discussed with reference to FIG. 8. Additionally, the shipper-tracking server module 464 may be in communication with the vendor tracking-server module (364 in FIG. 3).

FIG. 5 is a flow chart that illustrates the customer-tracking module. The flow chart comprises a sequence of blocks describing functional aspects of the customer-tracking module 510. In general, while functional flow charts are useful in providing illustration of the narrative of a computer method, it should be understood that sequences, functional steps, and decisions as illustrated often describe one of many implementations of the inventive aspects of the method. For example, the ordering of the blocks, the composition of processing described in the blocks, and the entry and exit points for decisions should not be taken as the only possible implementation of the method, as would readily be understood by one of ordinary skill in the art of computer programming.

In block 512, a customer-interface form is instantiated from a template object such as a web document described using the HTML markup language. The definition of the customer-interface form may include active components, such as locally executing scripts, links to CGI scripts, or properly formatted requests to web services. In this manner, the active components may perform certain portions of the method 510 in a distributed computing manner. So as not to obscure the present invention, the following discussion will assume that method 510 is implemented by way of program instructions that are associated with the customer-tracking module (256 in FIG. 2) operating on the customer computer (114 in FIG. 1). The customer-interface form may also be thought as an object comprising properties and methods.

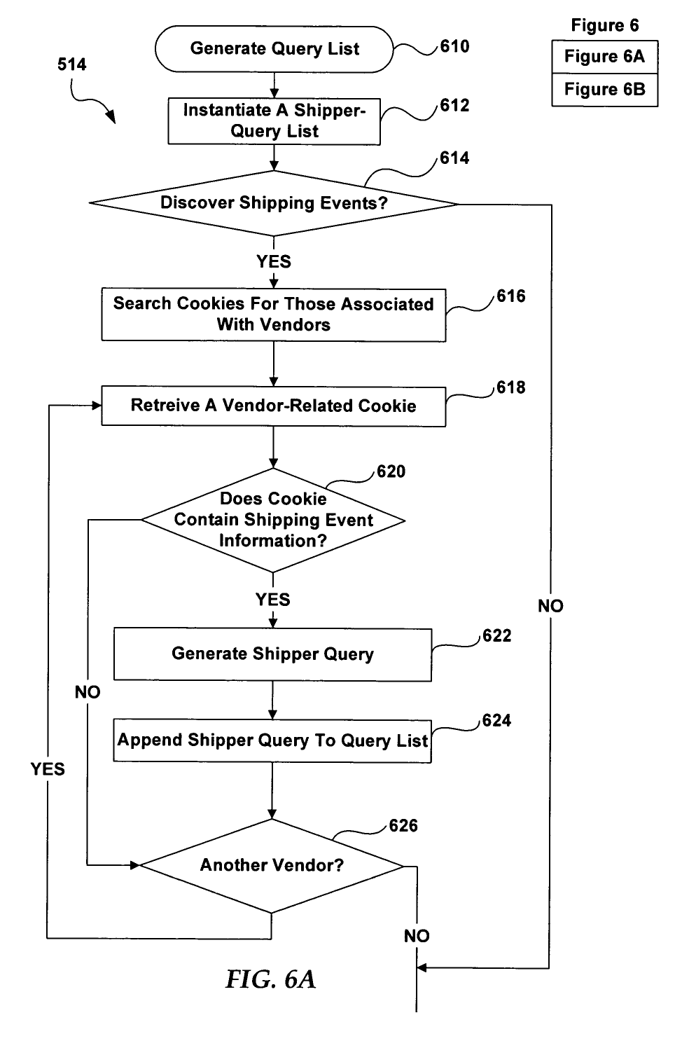

A shipper-query list is generated in block 514 according to a method discussed in detail below with reference to FIGS. 6A-B. In general, the shipper-query list comprises a set of dynamically generated queries that may variously obtain tracking information from shippers (106 in FIG. 1), vendors (104 in FIG. 1), or third parties (110 in FIG. 1) pertaining to one or more customers (102 in FIG. 1) associated with the customer computer (114 in FIG. 1) on which the customer-tracking module operates. As will be discussed in more detail below, a query comprises a transaction identifier and an explicit or implicit request for a server to return a list of transactions, if any, that are associated with the transaction identifier. For example, the transaction identifier may be a customer number, tracking number, or any other combination of information associated with the customer (102 in FIG. 1) that uniquely identifies that customer (e.g., first name, last name, zip code, etc.).

The queries assembled in the shipper-query list generated in block 514 are each processed in a loop beginning with block 516. The query is sent to the shipper (106 in FIG. 1) in block 518. Alternatively, the query may be sent to the vendor (104 in FIG. 1) or a third party (110 in FIG. 1) that has been previously supplied with the shipping information by the shipper (106 in FIG. 1).

As will be discussed below with reference to FIG. 8, the shipper (106 in FIG. 1) or delegated third party (110 in FIG. 1) processes the query and returns a query response. The query response is received from the shipper (106 in FIG. 1) in block 520, and the data in the query response is processed and appended to the customer-interface form in block 522. This processing generally comprises parsing the query response for data which is assigned to associated properties of the customer-interface form object or directly integrated with the textural and formatting elements of a web form.

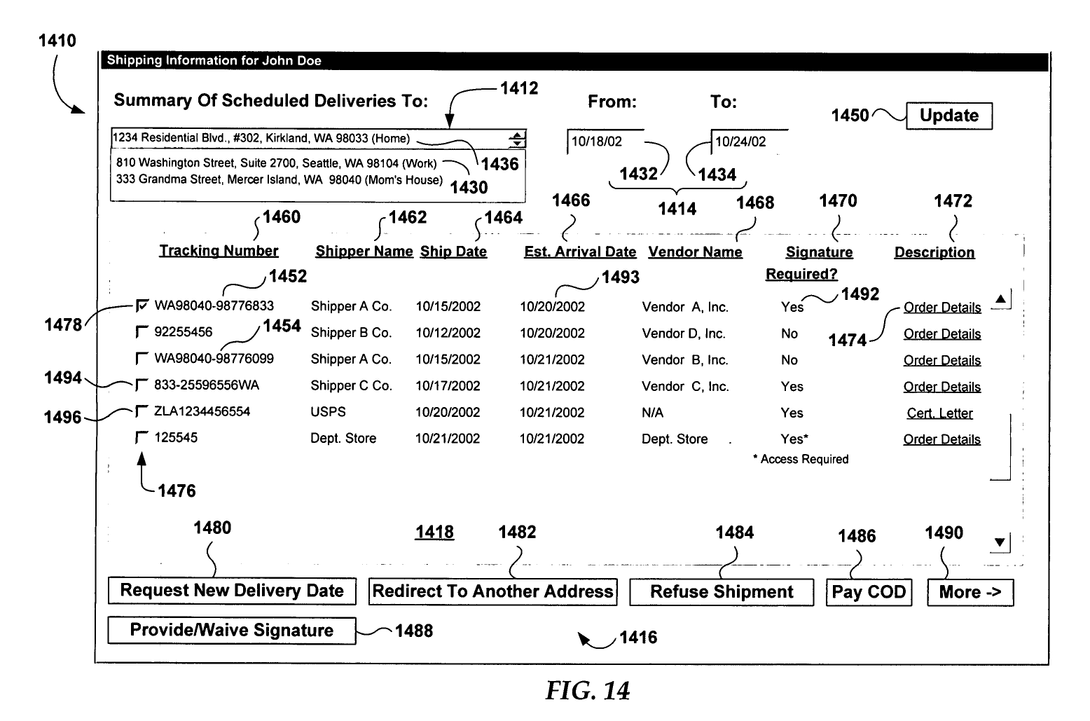

Decision block 524 returns control to block 516 if there is another query in the shipper-query list. When the processing of the shipper-query list is completed, the decision block 524 passes control to block 526, where the customer-interface form is finalized and made available to the client application/web browser (254 in FIG. 2). In general, the customer-interface form will be processed as a web page and displayed to the customer (104 in FIG. 1). As will be discussed below, with reference to FIG. 14, the customer (102 in FIG. 1) may request tracking information be acted upon, for instance, to modify shipping transaction information or preferences. The action request may comprise the customer (102 in FIG. 1) activating a web page element via the web browser (254 in FIG. 2), or may comprise an automated action administered by the client application (254 in FIG. 2) or other application (252 in FIG. 2).

Decision block 528 detects an action request, generally while waiting in a polling state that is responsive to an event generated by the web browser application (254 in FIG. 2). If no action is requested (e.g., the customer-interface form is unloaded from the web browser), then method 510 ends with block 530. Of course, the customer-tracking module may be activated at any time, for instance, by customer activation, or context sensing that activates the customer-tracking module when the customer computer (114 in FIG. 1) attempts to access a relevant web site (e.g., a visit to a shipper web server (118 in FIG. 1) or vendor web server (116 in FIG. 1)).

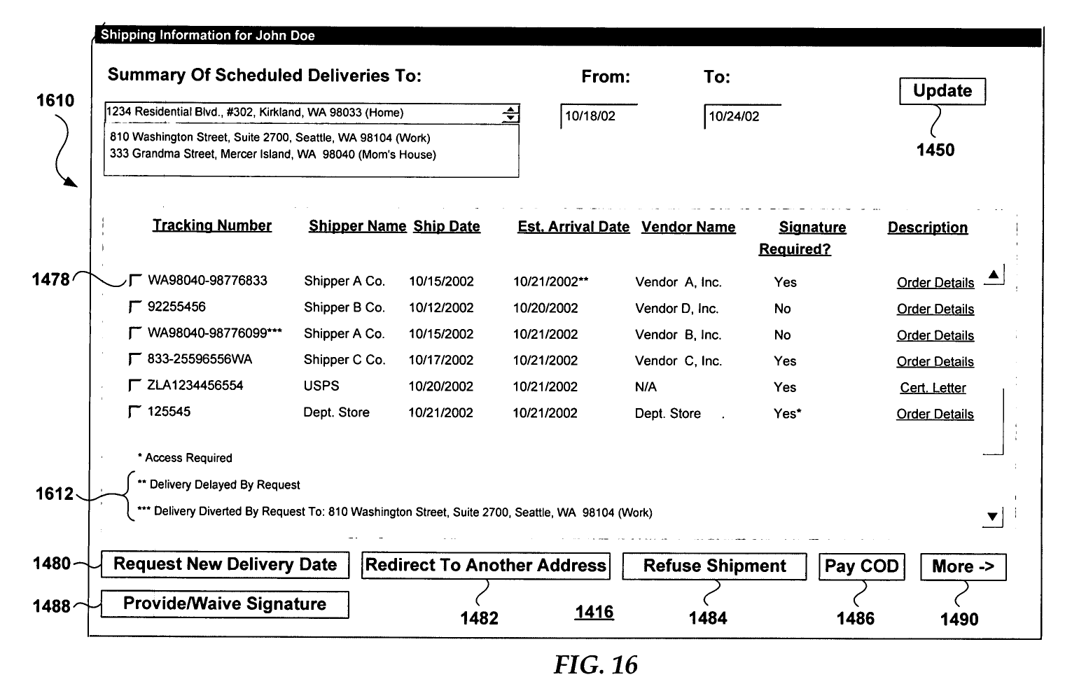

Action request parameters are received either in block 540 or automatically from applications (252 and 254 in FIG. 2). Another shipper query is generated in block 542 that includes the action request. The shipper query and action request are then sent to the shipper-tracking server module (464 in FIG. 4) or a third party (110 in FIG. 1), which processes the action request and returns a response. When the customer-tracking module receives the query response from the shipper in block 544, the customer-tracking module updates the customer-interface form with any data contained within or implied by the query response in block 546. An example of an updated customer-interface form is shown and discussed below with reference to FIG. 16. Control is then returned to the decision block 528 which waits in a polling state until a change in context which indicates that the customer-tracking module should be re-run 540 or exited 530.

FIGS. 6A-B is a flow chart that illustrates the generation of the shipper-query list. The shipper-query list is instanced in block 612, for instance, as an object or data file. The shipper-query list comprises one or more shipper queries pertaining to shipping transactions associated with the customer computer (114 in FIG. 1). In order to provide a clear understanding of the present invention, the following description aggregates all queries into the shipper-query list for processing. Of course, each shipper query may be processed independently without the intermediate step of creating a shipper-query list. In some embodiments this may actually be preferable. For example, the stateless nature of web servers and the difference in response times of various servers may actually favor an asynchronous implementation of the present invention that would be readily apparent to one of ordinary skill in the Internet programming arts. In essence, this means sending shipper queries when convenient in the process, aggregating the responses to those shipper queries as they are returned, and integrating those shipper-query responses into the customer-interface form after all shipping-query responses are retrieved or a default interval.

Decision block 614 determines whether to discover shipping events. If so, control is passed to block 616, where the customer computer (114 in FIG. 1) is searched for cookies (258 in FIG. 2) associated with the vendor (104 in FIG. 1). A processing loop begins, at block 618, by retrieving one of the discovered cookies. The cookie (258 in FIG. 2) is examined in decision block 620 to determine if the cookie contains any shipping information. If such information is found, control is passed to block 622, where a shipper query is generated based upon the shipping event information discovered in the cookie (258 in FIG. 2). The shipping query is then appended to the query list in block 624. Control is then passed to decision block 626 that determines if another vendor cookie has been found. If another vendor is found, control passes to block 618. When all vendors have been processed, as determined by decision block 626, or if the shipping events are not configured to be discovered, as determined by decision block 614, control is passed to block 640 in FIG. 6B.

In block 640, a pre-configured list of shippers is retrieved from either the customer computer 114 or an accessible server. The list of servers may include a set of known shipping companies that may be used for a default search for shipping events. Decision block 642 determines if a general shipping query should be performed, in which case control is passed to block 644 that selects all shippers in the list of shippers. A query is generated in block 646 for each shipper in the shipper list and then appended in block 648 to the query list.

Decision block 650 determines if all of the selected shippers in the shipper list have been processed, and redirects control to block 646 if they have not. Once all selected shippers have been processed, the decision block 650 passes control to block 652 that returns the query list to block 514 in FIG. 5. If a general shipping query is not to be performed, decision block 642 passes control to block 645, where a subset of the shippers in the shipper list can be selected. The subset of shippers is then passed for processing to the processing loop beginning with block 646.

FIG. 7 is a flow chart that illustrates the vendor-tracking server module. The vendor-tracking server module (364 in FIG. 3) may include routines based upon a notification model, a query model, or both. When configured for notification, the vendor-tracking server module provides shipping information to the customer (102 in FIG. 1) without requiring a previous prompt or query from the customer (102 in FIG. 1). Customer requests are also possible which return information in query responses, as is described elsewhere in the specification. If the customer (102 in FIG. 1) has requested notification, decision block 712 monitors the vendor computer (116 in FIG. 1) for the occurrence of an event that has been pre-configured to issue a notification to the customer computer (114 in FIG. 1). For example, the event may comprise a watchdog timer that periodically activates to indicate that a pre-defined interval has expired and that a notification should be sent. Another example of an event may be the receipt of shipping information from a shipper server (118 in FIG. 1). When notifications are requested, decision block 712 passes control to block 714, which obtains shipping information from the shipper-tracking server module (464 in FIG. 4) in much the same way as described in the query processing explained above, with reference to FIG. 5. The shipping information obtained in block 714 is then sent to the customer computer (114 in FIG. 1) in block 716. The process then repeats, in block 718, by returning control to the start of method 710.

If customer notification is not requested, or a notification event has not yet been detected in decision block 712, control is passed to decision block 720, which waits for a query from the customer computer (114 in FIG. 1). Decision blocks 712 and 720 are representative of asynchronous routines that wait for the occurrence of an event or the receipt of a query. When a query is detected by decision block 720, control is passed to block 714, where it is processed as is described above. While waiting for a query or a notification event, control is passed from decision block 720 to block 718, which causes the method 710 to repeat.

FIG. 8 is a flow chart that illustrates the shipper-tracker server module. Like the vendor-tracking server module (364 in FIG. 3) described above with reference to FIG. 7, the shipper-tracking server module (464 in FIG. 4) may include components to notify vendors or customers, respond to vendor or customer queries, or both. Decision block 812 determines when vendor or customer notifications are desired and monitors for events indicating that a notification should be issued. Upon the occurrence of a notification event, control passes from decision block 812 to block 814 where the method 810 obtains product-tracking information from a data base (e.g., (470-472 in FIG. 4)). This information may be accessed, for instance, through the shipper web service (462 in FIG. 4), an API (466 in FIG. 4), or other middleware application (452 in FIG. 4). Method 810 may also include processes shown as block 816 for acting upon the shipping information. For example, the shipping information may be modified, as will be discussed below beginning with FIG. 14, in accordance with a customer (102 in FIG. 1) request, or modified for the vendor's (104 in FIG. 1) benefit by, for instance, adding mark-ups to the shipping transaction or incremental billing for retrieval of the information request. The query information is then returned in block 818 and the process repeats, starting at block 820, which re-directs control to the beginning of method 810.

If notification queries have not been requested or a notification event has not yet occurred, decision block 812 passes control to decision block 822 that determines whether a query has been received from either the vendor (104 in FIG. 1) or the customer (102 in FIG. 1). If a query is received, decision block 822 passes control to block 814, where the query is processed to obtain the shipping information in a manner similar to that described above with regard to FIG. 5. If no query is detected by decision block 822, control is passed to block 820, which repeats method 810 in a polling pattern.

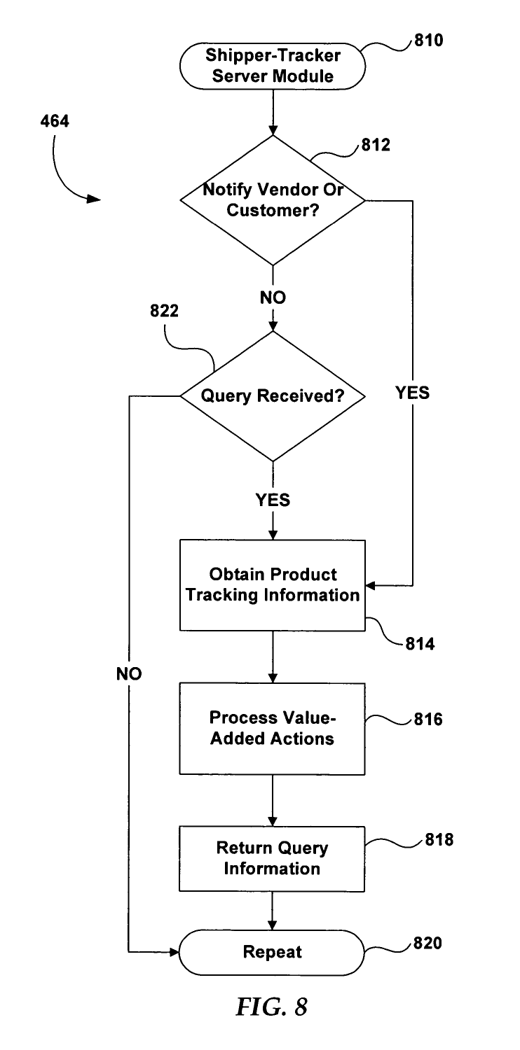

FIG. 9 is an example of a shipper list, which is illustrated for clarity as a simple data file, but just as easily could be a representation of a table stored in a database or extracted from any relational database pursuant to a query, generated in volatile memory as an object, etc. The shipper list comprises a plurality of records 912-920, which contain information for generating queries. For example, record 912 contains fields describing the name of a shipper 922, a shipper URL 924 that specifies a web address for the shipper, an entry for the location of a service description language (“SDL)” file 926. An SDL file 926 describes a schema recognized by the web service at the shipper URL 924 which defines the format of a properly formed query that will be accepted by the web service. SDL files 926 are designed to be automatically discoverable by query-generating programs and are widely understood in the art. Alternatively, the shipper's list may contain a field entry that defines a query template 928 that may be used to assemble a query in conjunction with an action request, for instance, formed in an HTTP GET command. Additionally, the various shipper records 912-920 may comprise different formats for query templates (e.g., 930). The individual shippers may also make provisions for additional fields supporting their own value-added services, such as the customer preferences field 932.

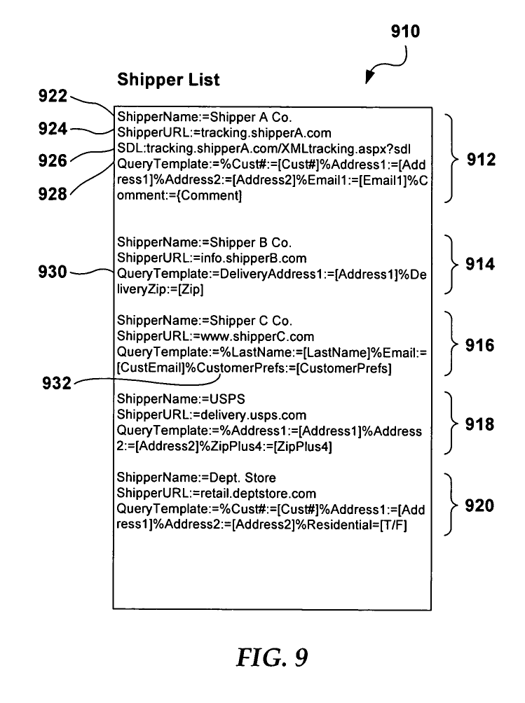

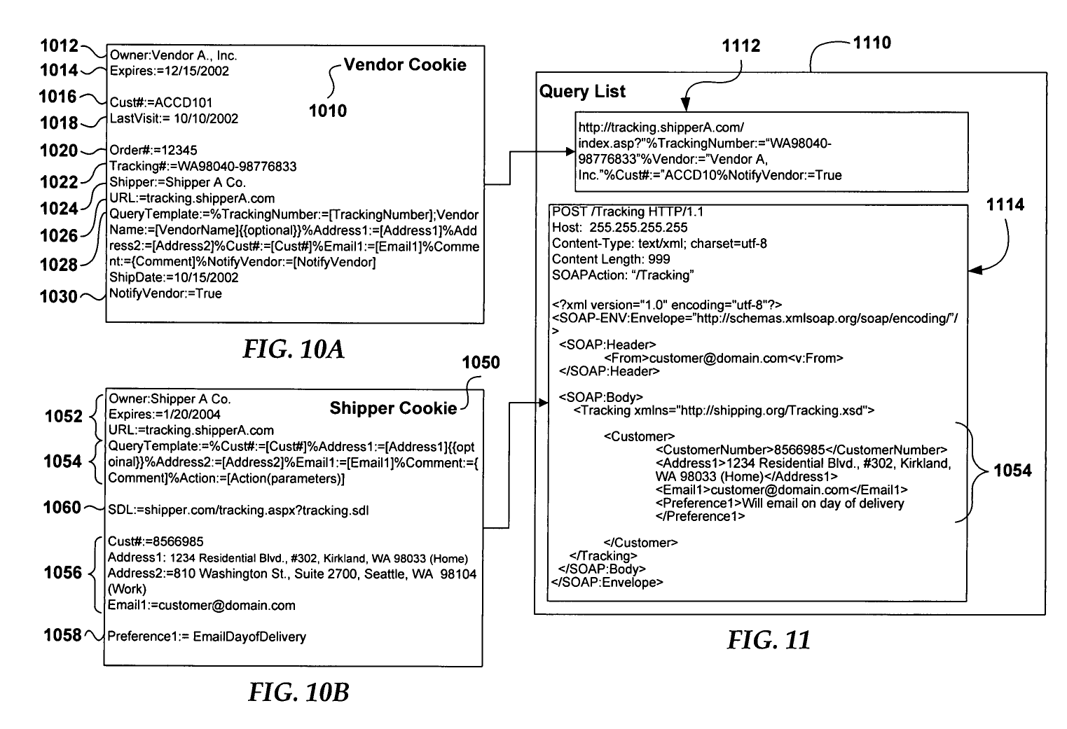

FIGS. 10A and 10B illustrate examples of cookies that may be deposited on the customer computer. In FIG. 10A, a vendor cookie 1010 includes various data, including the owner of the cookie 1012 and the expiration date of the cookie 1014. The vendor (104 in FIG. 1) stores information specific to the customer (102 in FIG. 1) in the vendor cookie 1010, such as a customer identification number 1016 and the date of the last visit 1018 to the vendor web site. The vendor cookie 1010 may also include information specific to transactions conducted by the customer computer (114 in FIG. 1) at the vendor web site. Each of these purchase transactions may include information fields used to generate shipper queries and the information may be periodically updated by the vendor-tracking service module via notifications (712 in FIG. 7). For example, a purchase transaction results in an order number 1020 of “12345” for which the vendor obtained a tracking number 1022 from a shipper 1024. This information can be stored with a URL 1026 for the shipper 1024, which can be used with a query template 1028 or an SDL file to generate a query 1112 in FIG. 11. The vendor cookie 1010 may also include fields that specify customer preferences 1030 that are then used to generate action requests.

A shipper may also deposit a shipper cookie on the customer computer that contains similar information to that described for the vendor cookie 1010. A shipper cookie 1050 generally contains shipper identification information 1052, query definition information 1054, customer identifying information 1056, and an SDL file 1060. The shipper cookie 1050 may also include fields for customer preferences 1058 or any other information.

A sample query list 1110 is illustrated in FIG. 11. Two possible forms of queries, 1112 and 1114, are illustrated for a preferred embodiment of the present invention. Both queries 1112 and 1114 are different forms of HTTP-compliant requests. Query 1112 illustrates an HTTP GET request and is created based upon the exemplary vendor cookie 1010. Query 1114 represents an HTTP-formatted POST request that utilizes simple object access protocol (“SOAP”), to access information based on data elements formatted according to the SDL file (1060 in FIG. 10B) specified in the shipper cookie (1050 in FIG. 10B) and using customer identification fields (1056 in FIG. 10B) and preferences (1058 in FIG. 10B).

In one embodiment of the invention, the various servers (116, 118, 120 in FIG. 1) and customer computers (114 in FIG. 1) exchange information via HTTP and SOAP protocols, exchanging data formatted according to XML markup standards. As described with reference to FIG. 4 above, a web service (462 in FIG. 4) may have an associated web service information file (474 in FIG. 4). The address of this web service information file (474 in FIG. 4) may be obtained by inquiry of the web service (462 in FIG. 4), through a directory service, or direct reference such as the SDL field (1060 in FIG. 10B).

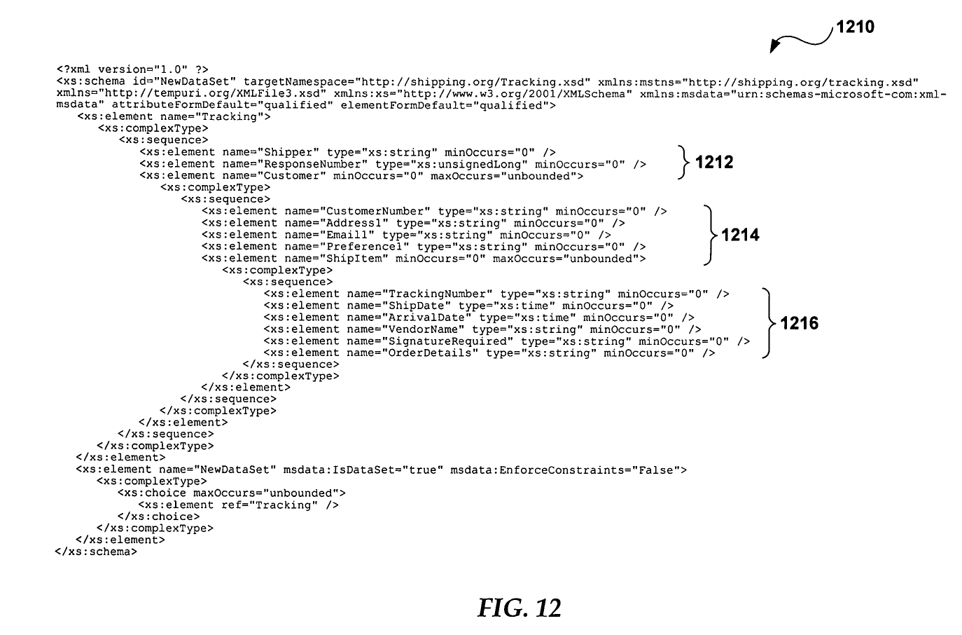

FIG. 12 illustrates an example of an XML schema definition. Queries formatted in accordance with the schema are guaranteed to be recognized by the owner entity. A schema 1210 may be defined for an individual entity or an entire industry. In the current context, an individual shipper (106 in FIG. 1) may define its own schema or may adopt a schema propounded by a shipping trade association. In general, the schema is a hierarchical relationship where there may be a plurality of entries of the same format that result from a query. For example, a single query response may include query response identification information 1212 which contains a plurality of customer information fields 1214, which in turn may include a plurality of shipping transaction data fields 1216.

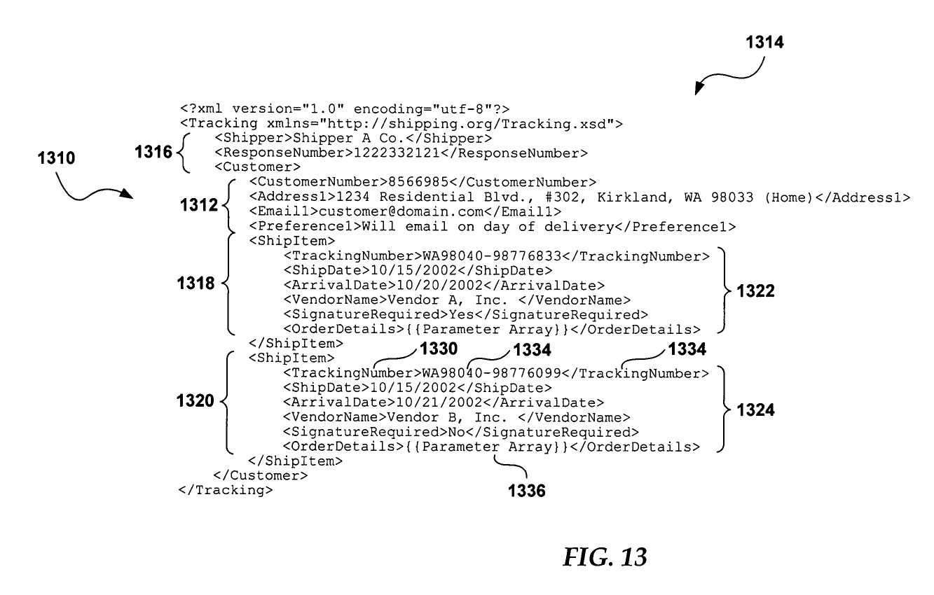

FIG. 13 illustrates an example of both a query and a query response formatted according to schema 1210 in FIG. 12. Query 1310 might include data for customer identification fields 1312 that are used by the web service (462 in FIG. 4) to return a query response 1314 with retrieved data including shipper response information 1316. The query response 1314 contains two shipping transaction records 1318 and 1320. Transaction data 1322 and 1324 are provided for the shipping transaction records 1318 and 1320 respectively. This information is easily parsed by program instructions (252, 254, or 256 in FIG. 2) on the customer computer (114 in FIG. 1) for presentation in the customer-interface forms described below with reference to FIGS. 14-16. The information is delimited by paired tags (e.g., 1330 and 1332) and may be passed as single data items 1334 or as parameter arrays 1336.

FIG. 14 shows an example of a customer-interface form. The customer-interface form 1410 generally includes customer-interface fields for selecting customer identification information 1412, search parameter information 1414, action-request elements 1416, and shipping-transaction information 1418. An example of the operation of the present invention will now be provided with reference to the customer-interface form illustrated in FIG. 14. Referring to FIG. 5, the customer-interface form is instantiated 512, filled 514-524, and displayed 526 as illustrated in FIG. 14. The query generation for filling the customer-interface form 1412 may include customer-selected fields 1430 or inputted parameters 1432 and 1434. In general, the initial filling of the customer-interface form 1412 will utilize default values (e.g., 1436), but may be modified by selection 1430 or input 1432 and 1434 by reactivation of the method 512 via a control button 1450. The transaction information 1418 is obtained from one or more response queries such as illustrated in FIG. 13. For example, entries 1452 and 1454 correspond to data contained in transaction information (1322 and 1324 in FIG. 13) and contained in the same response (1316 in FIG. 13). Columns 1460 through 1472 represent various data that may be obtained either through queries or from other sources. Many different types of data may be provided such as that generally indicated by order details 1474. The transaction information 1418 may be sorted by any individual column 1460-1472 and each individual data item in the transaction information 1418 may be hyper-linked to give further information pertaining to that data.

Action-request items 1416 allow for the performance of actions on particular transaction data records. For example, selection of a transaction record indicator 1476 designates the item or items on which an action request 1416 should be performed. In FIG. 14, the first transaction record 1478 is indicated for action. The action-request items 1416, as shown, include some of the potential actions possible pursuant to the present invention. For example, activation of button 1480 initiates a request for a delivery date other than the date displayed in the transaction information 1418 under the estimated arrival date column 1466, here shown to be “Oct. 20, 2002” 1493. Activation of button 1482 requests that the selected delivery transaction 1478 be re-directed to another address. By activating button 1484, an action can be initiated to refuse shipment of the indicated transaction record 1478. Additional web services can also be invoked, for instance, by activating a pay cash on delivery “COD”) button 1486 which would call a web service for e-commerce financial transactions to transfer a COD payment from an account associated with the customer computer (114 on FIG. 1) to the shipper computer (118 in FIG. 1). Activation of action button 1488 may allow a customer to provide or waive a signature required by the shipper (106 in FIG. 1) as part of transaction record 1478, as indicated in column 1470, here shown as 1492. Activation of a MORE button 1490 may lead to any other number of additional actions.

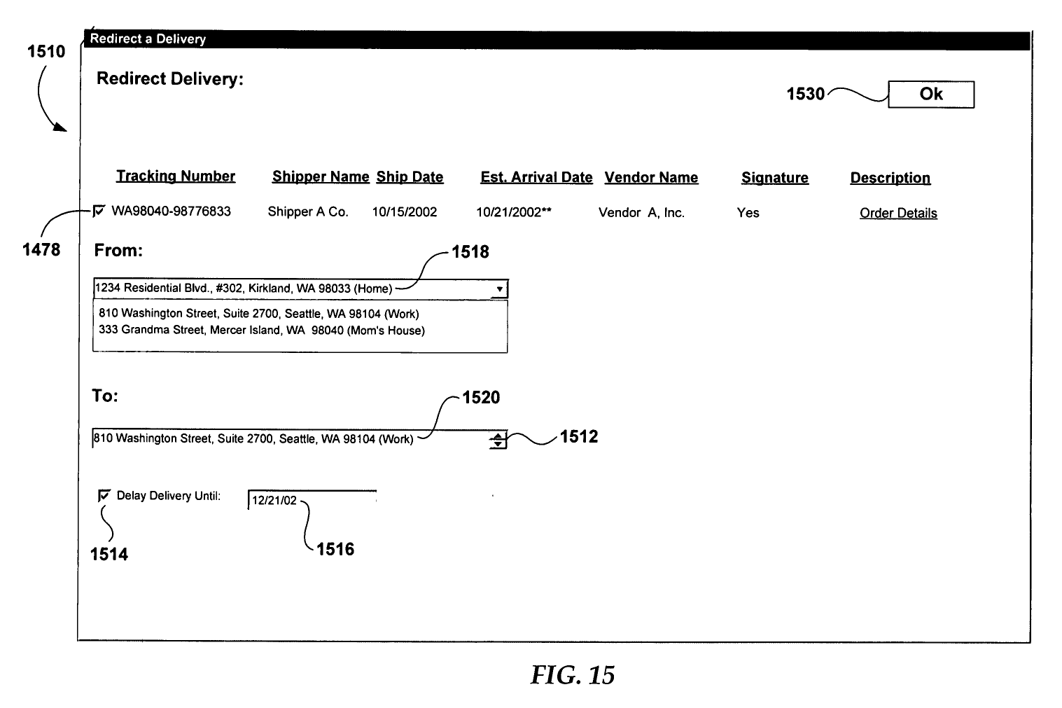

FIG. 15 illustrates an example of a customer-interface form through which the customer specifies delivery of the product to an alternate address and also delays delivery of the product until a particular delivery date. In the example illustrated in FIG. 15, the customer (102 in FIG. 1) has specified that the shipment originally directed to the customer's home address 1518 should be re-directed to the customer's work address 1520. The customer (102 in FIG. 1) has also specified that the delivery be delayed until “Oct. 21, 2002”, from its original arrival date scheduled for “Oct. 20, 2002” (1493 in FIG. 14). Through re-direction of the transaction, the customer (102 in FIG. 1) could coordinate the delivery of transactions (e.g., 1478, 1494, and 1496 in FIG. 14) to the same destination and on the same date, where it is more convenient for the customer (102 in FIG. 1) to provide required signatures (1470 in FIG. 14). Once the customer (102 in FIG. 1) has completed the customer-interface form 1510, the customer (102 in FIG. 1) selects an acknowledgement button 1530 which generates an action-request event detected by decision block 528 in FIG. 5.

FIG. 16 illustrates the customer-interface form of FIG. 14 following the modifications to transaction 1478 performed with reference to FIG. 15. The updated customer-interface form 1610 includes the revised information for transaction 1478 and may include action-request-response data 1612 obtained from the response of the shipper (106 in FIG. 1) taking the action (544 in FIG. 5). As mentioned above, action requests may be performed or administered by the vendor computer (116 in FIG. 1), server computer (118 in FIG. 1), or other computers (120 in FIG. 1) delegated by the shippers or vendors. The customer make take as many actions 1416 as are desired by selecting action buttons 1480-1490, as described above with reference to FIGS. 14-16.

Although the present invention has been described in terms of a particular embodiment, it is not intended that the invention be limited to this embodiment. Modifications within the spirit of the invention will be apparent to those skilled in the art. For example, the various tracking modules can be written in any number of different languages and be designed to read and respond to any number of different shipping information. The customer-interface form can be altered in form and in content in a number of different ways using a number of different fields to convey variable amounts of shipping information to the customer and allowing variable amounts of customer options for viewing and controlling displayed shipping information. Further, the customer-interface form could be made accessible only to certain users of the customer computer through the use of a user name and password requirement.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for the purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A system for tracking and controlling delivery, the system comprising:
a customer-interface form displayed on a computing device that displays shipping information for deliveries shipped by one or more shippers; and
a customer-tracking module running on the computing device that
retrieves shipping information stored on the computing device and enters shipping information into the customer-interface form,
receives and processes information entered into the customer-interface form by a customer, and
transmits requests to shippers in order to carry out shipping changes indicated by the customer by entering information into the customer-interface form.

2. The system of claim 1 wherein the shipping information displayed on the customer-interface form, to the customer, for each shipment, includes:
a tracking number;
shipper name;
delivery address; and
estimated delivery date.

3. The system of claim 1 wherein the customer-tracking module transmits requests and the computing device receives shipping information through Internet-based communications.

4. The system of claim 1 wherein the shipping information stored on the computing device is stored within one or more cookies.

5. The system of claim 4 wherein the shipping information stored within a cookie includes:
delivery identifier;
shipper identifier;
delivery address; and
shipping parameters.

6. The system of claim 1 wherein the customer-interface form displays vendor information in addition to shipper information for a delivery.

7. The system of claim 6 wherein the vendor information includes:
vendor name;
order number; and
shipping date.

8. The system of claim 1 wherein, when the customer changes or inputs new information into the customer-interface form to direct a change in delivery, the customer-tracking module processes the input information to generate and transmit the request to the shipper.

9. A shipper-tracking server module comprising:
a customer-request-receiving component;
a customer-request-handling component that parses received customer requests and accordingly updates stored shipping information; and
a shipping-information-transmission component that transmits shipping information for storage on a customer computing device.

10. The system of claim 9 wherein the customer-request-receiving component receives customer requests, and the shipping-information-transmission component transmits shipping information to customer computing devices, through Internet-based communications.

11. The system of claim 9 wherein the shipping information transmitted to the customer computing device is stored on the customer computing device in a cookie.

12. A method for tracking and controlling delivery by one or more shippers, the method comprising:
displaying a customer-interface form on a computing device to a customer by retrieving shipping information stored on the computing device and entering the shipping information into a customer-interface form for display to a customer;
receiving and processing information entered into the customer-interface form by the customer; and
transmitting requests to shippers in order to carry out shipping changes indicated by entering information into the customer-interface form by the customer.

13. The method of claim 12 further including displaying, to the customer through the customer-interface form, for each shipment:
a tracking number;
shipper name;
delivery address; and
delivery date.

14. The method of claim 12 wherein shipping information is received by the computing device and requests are transmitted to shippers through Internet-based communications.

15. The method of claim 12 wherein the shipping information stored on the computing device is stored within one or more cookies.

16. The method of claim 15 wherein the shipping information stored within the cookie includes:
delivery identifier;
shipper identifier;
delivery address; and
shipping parameters.

17. The method of claim 12 further including displaying vendor information, in addition to shipper information, for a delivery through the customer-interface form.

18. The method of claim 17 wherein the vendor information includes:
vendor name;
order number; and
shipping date.
